(19) United States
(12) Patent Application Publication
(10) Pub. No.: US 2013/0234618 A1
(43) Pub. Date: Sep. 12, 2013

(54) Single Input Power Wire - Multi Function Control

(71) Applicant: WHELEN ENGINEERING COMPANY, INC., Chester, CT (US)

(72) Inventor: James L. Stopa, East Hampton, CT (US)

(73) Assignee: WHELEN ENGINEERING COMPANY, INC., Chester, CT (US)

(21) Appl. No.: 13/791,973

(22) Filed: Mar. 9, 2013

Related U.S. Application Data
(60) Provisional application No. 61/609,038, filed on Mar. 9, 2012.

(51) Int. Cl. H05B 37/02

(52) U.S. Cl. CPC H05B 37/02
USPC 315/297

(57) ABSTRACT

A multifunction control circuit is responsive to a condition of the input power to selectively activate alternative functionality. In one embodiment, a μC is configured to monitor the input voltage, looking for a gap in the input voltage of a pre-determined duration, which indicates to the μC that the second (or additional) function is desired. This embodiment of the control circuit includes a 5 volt regulator configured to ensure sufficient power to the μC during an interruption of input power intended to present a function change signal. Alternatively, the control circuit may be constructed to monitor a change in the polarity of the input power and change functionality in response to changes in the polarity of applied voltage.

### BACKGROUND

The present disclosure relates to control of electronic circuits and specifically to control of electronic circuits in situations where access to the circuit is limited.

For example, a typical manual articulating light mounted on the “A” pillar of a police vehicle only has one function, which would be a high intensity halogen spotlight. The wiring from this light bulb to the ON\OFF switch inside the vehicle must travel through a very small conduit and typically uses only one wire for power, with ground supplied through the vehicle chassis. An exemplary articulating light is shown in FIG. 1. With the advent of LED technology, this spot light could support multiple functions, such as a flashing warning light or California steady red light in combination with the traditional high intensity spotlight. This multiple feature light poses the problem of how to control functionality and supply power to a multifunction electronic circuit with only a single wire.

### SUMMARY OF THE DISCLOSURE

A solution to this problem comprises incorporating a circuit including a microcontroller (μC) into the head of the light assembly (the head being that portion of the articulating light positioned outside the vehicle). The μC is configured to monitor the input voltage delivered to the head, looking for a gap in the input voltage of a pre-determined duration, which indicates to the μC that the second (or additional) function is desired. The μC, filters the voltage drop out pulse width and determines whether the pulse is less than 50 ms (noise), or greater than 500 ms, (OFF Command) pulse. A voltage gap of between 50 ms and 500ms is the signal to activate the second function. The 5 volt regulator delivering power to the μC is configured such that the 5 volts will “hold up” approximately 1.5 seconds to guarantee that the μC will operate during a “valid” “drop out” voltage pulse. The μC needs a minimum of 2 outputs which will drive current regulators for the “Warning” LED's and the steady WHITE spotlight LED's.

An alternative solution is a circuit arranged to monitor the polarity of the input voltage applied to the light. A first polarity applied results in a first function being activated, while the opposite polarity activates the alternative, second function.

### BRIEF DESCRIPTION OF THE DRAWINGS

FIG. 1 illustrates a manual articulating spotlight incorporating a single wire multifunction control circuit and LED combination warning and spot light according to aspects of the present disclosure;

FIG. 2 schematically illustrates a first embodiment of a single wire input multifunction control circuit according to aspects of the disclosure;

FIG. 3 graphically illustrates input voltage, power output of the voltage regulator and output of the μC for the circuit of FIG. 2;

FIG. 4 schematically illustrates an alternative embodiment of a single wire control circuit configured to monitor the polarity of the input power according to aspects of the disclosure.

### DETAILED DESCRIPTION OF THE DISCLOSED EMBODIMENTS

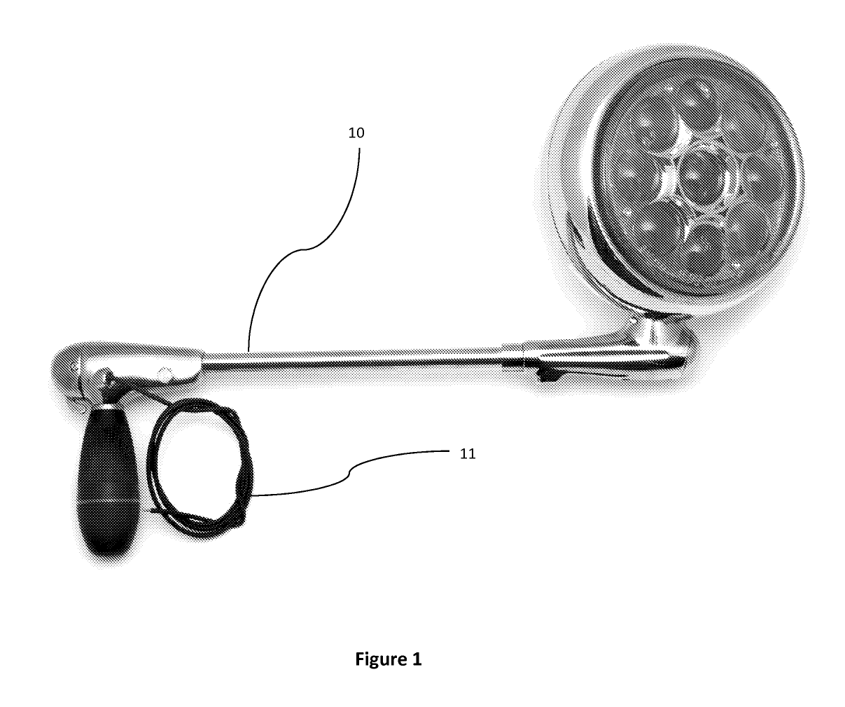

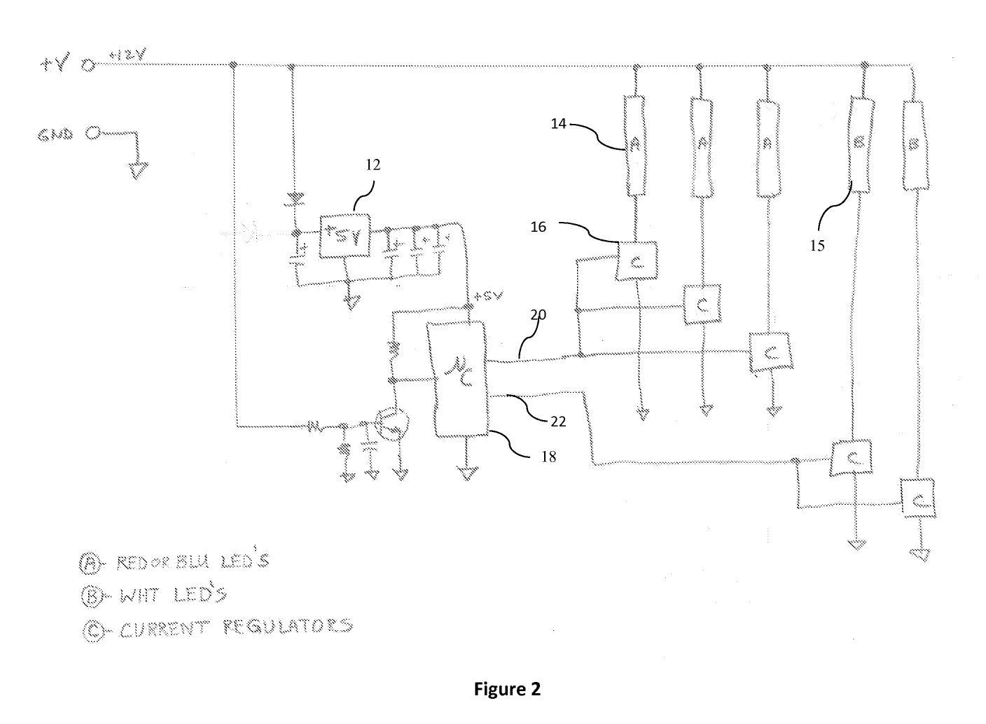

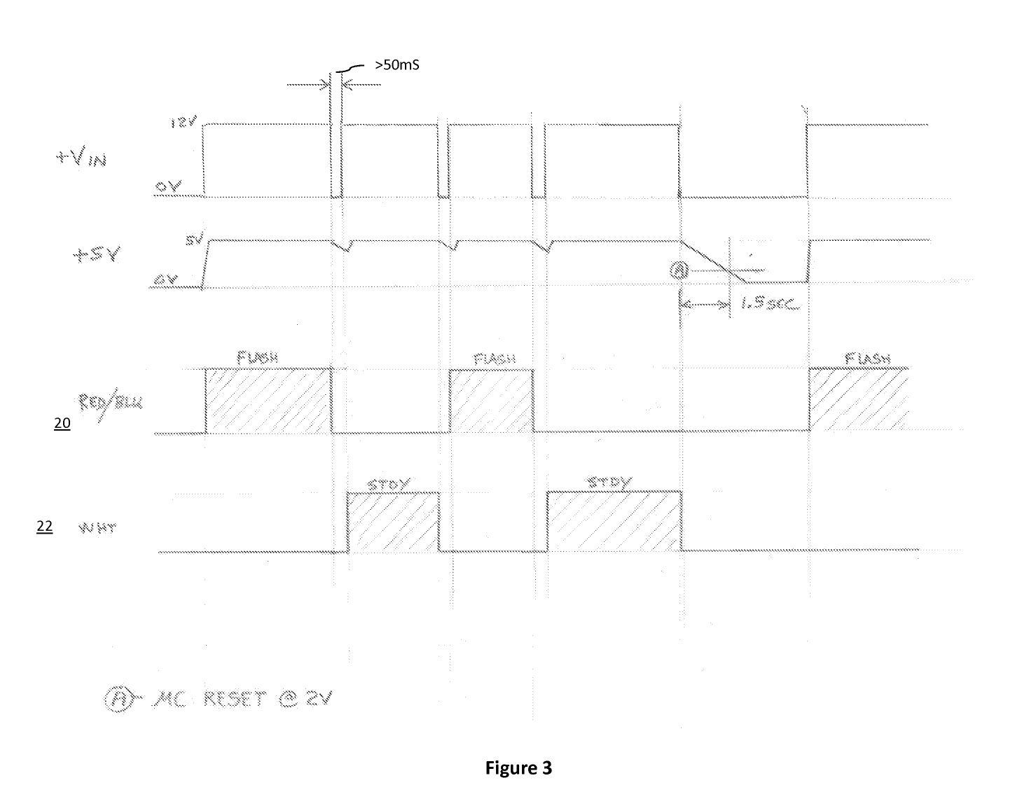

FIG. 1 illustrates a spotlight configured for mounting in the A pillar of an emergency vehicle. A hollow shaft 10 passes through the A pillar and defines a passage for a single wire 11 which supplies power to the light generator in spotlight. A first exemplary embodiment of a circuit permitting multifunction control and power through a single wire is illustrated in FIG. 2. The voltage regulator 12 is provided with capacitors that store sufficient electrical power that the μC has power for approximately 1.5 seconds after voltage +V is removed from the input/power wire. The relationship between input power +V and power delivered to the μC is shown in FIG. 3 in the graphical presentation labeled +5. Every time this circuit is powered up, (Cold Start), the μC flashes the Warning LED's (MODE 1), with μC output 20 active. As illustrated in FIG. 3, if the input voltage drops out for a time period of between 50 ms and 500 ms, the μC will switch from the flashing Warning mode, (MODE 1), to a Steady Spot light mode, (MODE 2), with μC output 22 active. If the input voltage drops out again between 50 ms and 500 ms, the uC will switch back to the flashing Warning light mode, (MODE 1) and μC output 20 is active again. If the input voltage drops out for less than 50 ms, the μC is programmed to ignore this event and consider it as noise. If the input voltage drops out for more than 500 ms, the μC will consider it as an OFF command and is programmed to reset the circuit to the flashing Warning light mode, (MODE 1) and shut down. If the input voltage drops out for a duration greater than 1.5 seconds, at which time the +5 volt regulator 12 will drop below 2 volts, the μC will reset and will start from a “(Cold Start)” start when the input voltage is applied to the circuit again. The timing and functionality set forth with respect to this embodiment can be adjusted, depending upon the intended use of the multifunction control circuit.

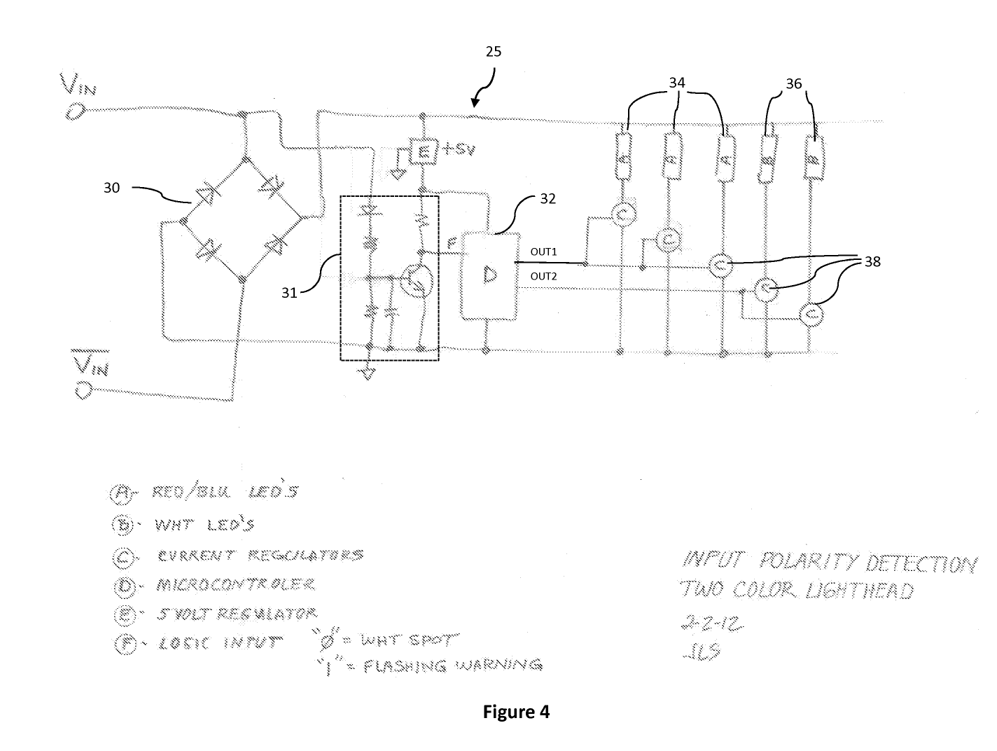

In an alternative second embodiment of a circuit for multifunction control through a power delivery wire is illustrated in FIG. 4, the circuit 25 employs a bridge rectifier input 30, a microcontroller (μC) 32, LED arrays 34, 36 and current regulators 38. The bridge rectifier 30 allows the circuit 25 to work with the input voltage Vᵢₙ connected in a positive or negative polarity. A logic circuit 31 connected to the positive input side of the bridge rectifier 30 allows the circuit 25 to be responsive to only the positive polarity input. The μC 32 monitors this logic signal at input F and can make a determination whether the input polarity is positive or negative. If the circuit powers up and the input logic signal F at the μC 32 is low, “0”, the uC will output a “Steady White Spotlight” function with output 2 of the μC 32 active. If the power input is reversed or negative, the μC 32 will sense a logic high at F and the μC 32 will output a “Flashing Warning Signal” function with output 1 of the μC 32 active.

This circuit operation is very simple. An input “Positive” polarity will cause the light to activate the White Spotlight mode of operation. An input “Negative” polarity will cause the light to activate the flashing RED or BLUE mode of operation. Either a small relay circuit or “H” bridge output driver circuit will be needed to drive this lamp to make it seamless to the operator. Switches are available which apply alternative polarity to the circuit. This circuit may require two wires through the A pillar.

What is claimed:

1. A multi function control circuit comprising:
a voltage input to which an input voltage is applied;
a voltage regulator connected to said voltage input and configured to maintain a voltage output above a first predetermined value for at least a first predetermined time after said input voltage is interrupted;
a logic circuit connected to said voltage output and arranged to sense at least one condition of said input voltage and having at least first and second outputs;
a first function responsive to said first output of said logic circuit; and
a second function responsive to said second output of said logic circuit,
wherein said logic circuit changes the state of said first output in response to a first state of said at least one condition and said logic circuit changes the state of said second output in response to a second state of said at least one condition, said first and second outputs being activated in the alternative.

2. The multi function control circuit of claim 1, wherein said at least one condition is an interruption of said input voltage.

3. The multifunction control circuit of claim 2, wherein said logic circuit is configured to monitor the duration of said interruption.

4. The multifunction control circuit of claim 3, wherein said logic circuit ignores interruptions below a first duration and changes the state of said first and second outputs in response to an interruption having a duration greater than said first duration and below a second duration.

5. The multifunction control circuit of claim 4, wherein said logic circuit resets the state of said first and second outputs to a default condition in response to an interruption greater than said second duration.

6. The multifunction control circuit of claim 1, wherein said first function is the application of electrical energy to a first light emitter to generate a first light emission pattern in response to a change of state at said first output, and said second function is the application of energy to a second light emitter to generate a second light emission pattern in response to a change of state of said second output.

7. The multifunction control circuit of claim 6, wherein said at least one condition is the polarity of said input voltage and said logic circuit sets said first and second outputs to a first condition in response to a first polarity and sets said first and second outputs to a second condition in response to a second polarity, said first and second conditions corresponding to a activation of said first or said second light emitter, respectively.
